(19) United States
(12) Patent Application Publication
(10) Pub. No.: US 2013/0311315 A1
(43) Pub. Date: Nov. 21, 2013

(54) SYSTEMS AND METHODS FOR MANAGING GROUP BUY TRANSACTIONS

(71) Applicant: Matthew Scott Zises, San Jose, CA (US)

(72) Inventor: Matthew Scott Zises, San Jose, CA (US)

(73) Assignee: eBay Inc., San Jose, CA (US)

(21) Appl. No.: 13/476,811

(22) Filed: May 21, 2012

(51) Int. Cl. G06Q 30/06

(52) U.S. Cl. 705/26.2

(57) ABSTRACT

A method and a system for determining a group buy preference corresponding to a group of social media platform users, determining an appropriate retailer corresponding to the determined group buy preference, and transmitting a request for a group buy deal corresponding to the group buy preference to the appropriate retailer.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2012, All Rights Reserved.

### TECHNICAL FIELD

The present application relates generally to data management in a network and, in one specific example, to systems and methods for managing group buy transactions.

### BACKGROUND

Group buy websites have emerged as a major player in online shopping business. Such websites operate based on the concept of group buying, wherein products and services are offered at significantly reduced prices on the condition that a minimum number of buyers will agree to purchase the product or service.

Conventional group buy websites approach merchants first, in order to negotiate deals with the merchants by promising to deliver a number of customers in exchange for discounts. Thereafter, the websites advertise the deal (e.g. as a featured “deal of the day”), wherein the deal becomes effective once a set number of people agree to buy the product or service. Buyers then receive a voucher to claim their discount at the merchant.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram of an example system, according to various embodiments.

FIG. 3 is a flowchart illustrating an example method, according to various embodiments.

FIG. 4 illustrates an example portion of a social media profile page hosted on an online social media platform, according to various embodiments.

FIG. 5 is a flowchart illustrating an example method, according to various embodiments.

FIG. 6 is a flowchart illustrating an example method, according to various embodiments.

FIG. 7 illustrates an example portion of a web-accessible user interface hosted by an application server, according to various embodiments.

FIG. 8 illustrates an example portion of a web-accessible user interface hosted by an application server, according to various embodiments.

FIG. 9 illustrates an example portion of a web-accessible user interface hosted by an application server, according to various embodiments.

FIG. 10a illustrates an example portion of an invitation message transmitted to a social media platform profile of a user, according to various embodiments.

FIG. 10b illustrates an example portion of an invitation post posted on a social media platform profile page of a user, according to various embodiments.

FIG. 10c illustrates an example portion of an invitation post posted on a social media platform profile page of a user, according to various embodiments.

FIG. 11 illustrates an example portion of a web-accessible user interface hosted by an application server, according to various embodiments.

FIG. 12 illustrates an exemplary database that lists plural candidate group buy preferences, and plural retailers corresponding to each of the candidate group buy preferences according to various embodiments.

FIG. 13 illustrates an example portion of a web-accessible user interface hosted by an application server, according to various embodiments.

FIG. 14 illustrates an example of a group deal request generated by an application server, and transmitted by the application server to a retailer, according to various embodiments.

FIG. 15 illustrates an example of a message transmitted from an application server to a user, according to various embodiments.

FIG. 16 is a block diagram of an example system, according to various embodiments.

FIGS. 17-19 illustrate exemplary database records, according to various embodiments.

FIG. 20 is a flowchart illustrating an example method, according to various embodiments.

FIG. 21 is a flowchart illustrating an example method, according to various embodiments.

FIGS. 22 and 23 illustrate exemplary database records, according to various embodiments.

FIG. 24 is a flowchart illustrating an example method, according to various embodiments.

FIG. 25 is a diagrammatic representation of a machine in the example form of a computer system within which a set of instructions, for causing the machine to perform any one or more of the methodologies discussed herein, may be executed.

### DETAILED DESCRIPTION

Example methods and systems for managing group buy transactions are described. In the following description, for purposes of explanation, numerous specific details are set forth in order to provide a thorough understanding of example embodiments. It will be evident, however, to one skilled in the art that the present invention may be practiced without these specific details.

The various embodiments describe a system that analyzes a social network (e.g., social media profile pages of members of a social networking website) in order to determine likely purchase preferences of the members of the social network. The system then identifies merchants corresponding to the determined purchase preferences, and automatically communicates, without human intervention, with these merchants in order to facilitate the offering of group buy deals related to these purchase preferences.

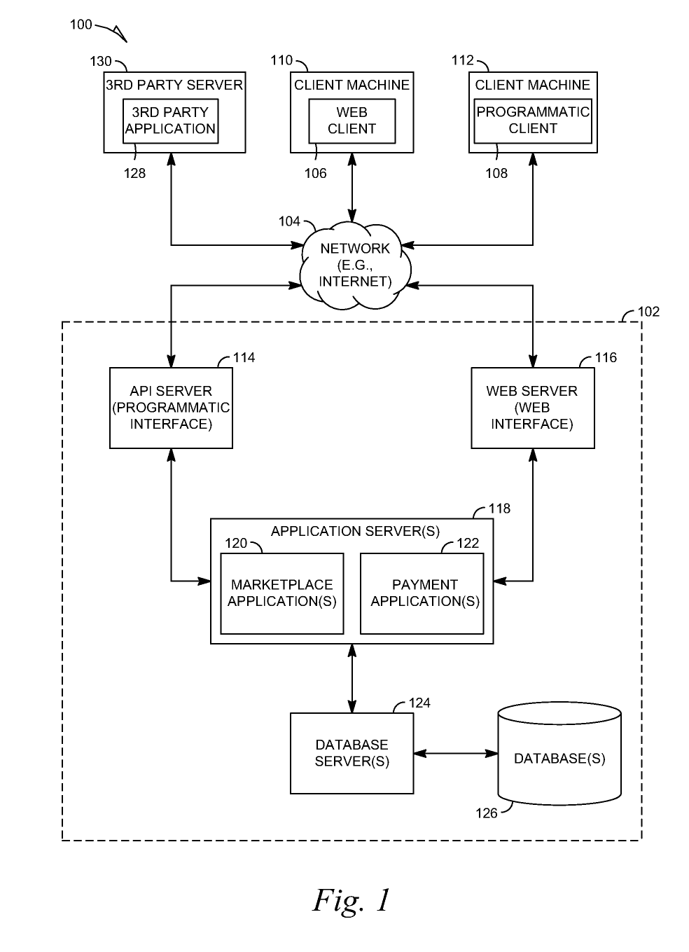

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

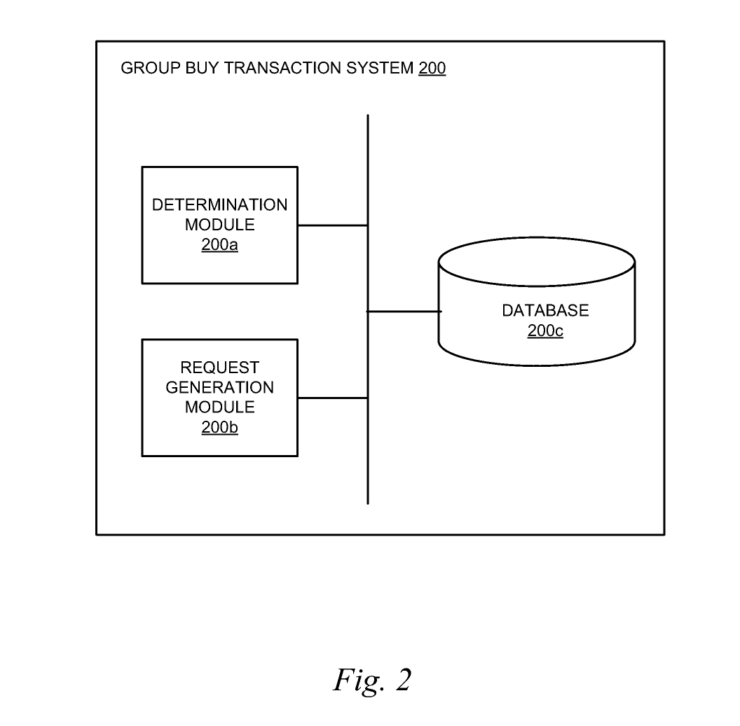

Turning now to FIG. 2, a group buy transaction system 200 includes a determination module 200a, a request generation module 200b, and a database 200c. The modules of the group buy transaction system 200 may be implemented on a single device, such as a group buy transaction server or group buy transaction device, or on separate devices interconnected via a network. The aforementioned group buy transaction server or group buy transaction device may correspond to, for example, one of the client machines (e.g. 110, 112) or application server(s) 118 illustrated in FIG. 1.

According to various exemplary embodiments described in greater detail below, in connection with the depicted user interfaces, the determination module 200a is operable to determine a group buy preference for a group of social media platform users. A ‘group buy preference’, as described throughout this disclosure, indicates a partiality of one or more social media platforms users to make a purchase within a specific retail category, such as video game products or Chinese cuisine. Thus, the group buy preference may correspond to, identify, or be associated with a retail category of interest (e.g. video games, Chinese food) of one or more users, and may indicate a likely purchase preference of the one or more users for purchasing products or services related to such retail categories of interest. The determination module 200a may determine the group buy preference based on, for example, user profile information extracted from social media profiles associated with the social media users (e.g. social media profile pages on a social networking website such as Facebook® or Twitter®).

The request generation module 200b is configured to determine retailers corresponding to the retail category associated with the group buy preference. The request generation module 200b is also configured to generate and transmit a request for a group buy deal corresponding to the aforementioned group buy preference to the aforementioned retailer, the request including an indication of the retail category.

Thus, based on the embodiments of this disclosure, considerable improvements over conventional group buy websites may be realized. For example, conventional group buying enterprises operate by approaching a merchant first in order to negotiate a deal, and then posting the deal as a “deal of the day” on the group buy website. The deals are in not targeted at the specific users of the group buy website. Thus, users of conventional group buy website are forced to parse through large numbers of deals for seemingly random products and services that are not necessarily relevant to them.

In contrast, in accordance with various exemplary embodiments, a group buying system analyzes a social network in order to determine retail categories of interest (e.g. hiking, Chinese food, etc.) indicating likely purchase preferences of users and their friends, and then approaches providers of products or services related to such retail categories of interest.

Thus, users of the group buy systems have leverage when approaching a retailer with a request for a group buy deal (e.g. “we have 20 people who are enthusiasts and would purchase a deal on X, what can you do for us?”), and the system promotes the offering of group deals that users actually want. As a result, consumers are satisfied because they receive deals that are relevant to them and which may result in significant cost savings. In addition, the retailer is satisfied because they can immediately deal with customers who actually want their products, with a high likelihood of conversion. Moreover, knowing information about these customers may be useful to the retailer for their marketing efforts in the future.

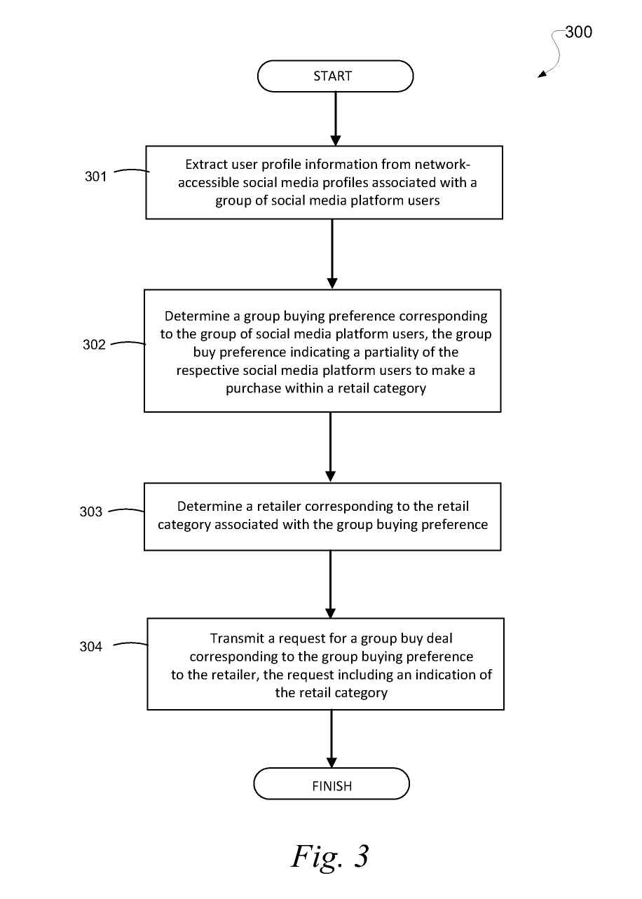

Turning now to FIG. 3, flowchart 300 illustrates an example method 300, according to various embodiments described in more detail below. The method 300 may at least partially be performed by a group buy transaction system (or a similarly configured group buy transaction apparatus), such as group buy transaction system 200 illustrated in FIG. 2. In step 301, the system extracts user profile information from network-accessible social media profiles associated with a group of social media platform users. In step 302, the system determines a group buy preference corresponding to the group of social media platform users, based on the user profile information extracted from network-accessible social media profiles associated with the social media platform users. The group buy preference may indicate a partiality of the respective social media platform users to make a purchase within a retail category. In step 303, the system determines a retailer corresponding to the retail category associated with the group buy preference determined in step 302. Finally, in step 304, the system transmits a request for a group buy deal corresponding to the group buy preference determined in step 302 to the retailer determined in step 303, the request including an indication of the retail category.

### Determination of Group Buy Preference

As described herein, the determination module 200a of a group buy transaction system is operable to determine a group buy preference for a group of social media platform users. A ‘group buy preference’, as described throughout this disclosure, indicates a partiality of one or more social media platforms users to make a purchase within a specific retail category, such as video game products or Chinese cuisine. Thus, the group buy preference may correspond to, identify, or be associated with a retail category of interest (e.g. video games, Chinese food) of one or more users, and may indicate a likely purchase preference of the one or more users for purchasing products or services related to such retail categories of interest.

According to an exemplary embodiment, the determination module 200a automatically determines, without human intervention, the group buy preference of social media users, based on user profile information extracted from social media profiles associated with the social media users. The social media profile is generally a profile page hosted on a social media website (as opposed to an email or private message), wherein the profile page is visible to other users. For example, the users may be members of an online social networking platform or online social networking website such as Facebook® or Twitter®, and the social media profiles associated with the users may correspond to the user's social media “profile pages”, such as a Facebook® profile page or Twitter® profile page. The term user profile information, as used throughout this disclosure, refers to any information included in or accessible via the social media profile page of the user by other users of the online social networking platform. For example, the user profile information may include identification information (name, username, email address, geographic address, networks, location, phone number, etc.), education information, employment information any images or graphics displayed on the profile page, any text or characters on the profile page, any links or URLs on the profile page, and so forth.

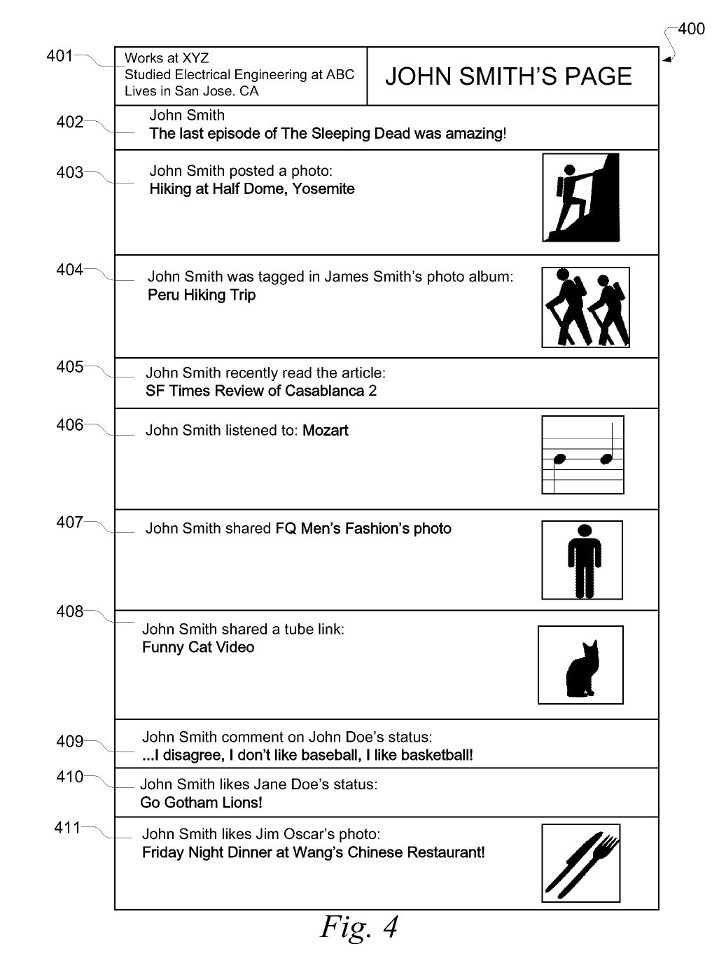

An example of a social media profile page 400 of a user (e.g., a Facebook® page of a user “John Smith”) is illustrated in FIG. 4. As seen in FIG. 4, the profile page includes identification information 401, such as the user's employment history (“works at XYZ”), education history (“Studied Electrical Engineering at ABC”) and geographic address/location information (“Lives in San Jose, Calif.”). The user's profile page also includes various posts, such as user John Smith stating that “The last episode of the Sleeping Dead was amazing!” (402), the user John Smith posting a photo “Hiking at Half Dome, Yosemite” (403), and so forth. All this information collectively corresponds to “user profile information” that may be extracted from the social media profile page of the user, in order to determine a group buy preference for the user.

The determination module 200a may crawl through all the data, metadata, and information associated with the user's publically accessible profile page. If the group buy system has an appropriate access agreement with the social networking platform and/or the user, the group buy system may also crawl through all the data, metadata or information associated with the user's private profile page. The system can access the social network platform itself to access social media identity information or user profile information regarding the registered user from information available in the user's social profile. Any publically available social media identity information regarding the user may be obtained from other social media or online sources as well. Social media platforms may expose social media identity information in some sort of application programming interface (API) that is accessible by the system. Thus, the system may retrieve or be fed user profile information of the user profile pages from application programming interfaces (APIs) that are exposed by the respective social medial platforms.

After the determination module 200a has extracted the user profile information from the user profile pages of one or more social media users, the determination module 200a analyzes the user profile information in order to automatically determine the group buy preference for the one or more users.

According to an aspect, the determination module 200a may perform a textual analysis of at least a portion of the alphanumeric text data included in the user profile information to detect one or more keywords in the user profile information. For example, with reference to the user profile page 200 of FIG. 2, textual analysis of the user profile information therein may identify the keywords “The Sleeping Dead” (202), “Hiking”, “Half Dome” and “Yosemite” (203), “Peru”, “Hiking” and “Trip” (204), “SF Times” and “Casablanca 2” (205), “Mozart” (206), “FQ Men's Fashion's” (207), “Cat” (208), “basketball” (209), “Gotham Lions” (210), “Wang's Chinese Restaurant” (211), and so on.

Thereafter, the determination module 200a may associate the one or more keywords with one or more retail categories of interest. For example, the text from the user profile information may be compared with one or more database records (e.g., database 200c in FIG. 2) identifying plural keywords corresponding retail categories. For example, the keywords “The Sleeping Dead” may be associated with the retail categories of television and, in particular, the television program ‘The Sleeping Dead’. Similarly, the keyword “Hiking” may be associated with the retail categories of hiking, sports, recreation, athletics, and so forth. Similarly, the keywords “Wang's Chinese Restaurant” may be associated with the retail category of Chinese cuisine.

Finally, the determination module 200a may determine that the group buy preference of the user corresponds to, identifies, and/or is associated with the aforementioned retail categories of interest, such as the television show ‘The Sleeping Dead’, sports, hiking, Chinese cuisine, and so on.

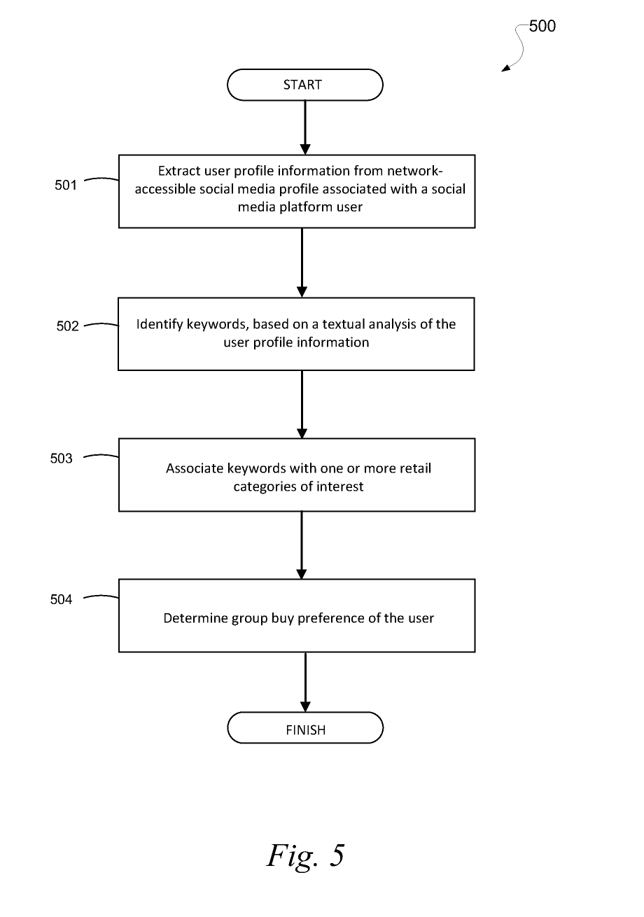

Turning now to FIG. 5, flowchart 500 illustrates an example method 500, according to various embodiments described in more detail below. The method 500 may at least partially be performed by a group buy transaction system (or a similarly configured group buy transaction apparatus), such as group buy transaction system 200 illustrated in FIG. 2. In 501, the system extracts user profile information from network-accessible social media profile associated with a social media platform user. In 502, the system identifies keywords, based on a textual analysis of the user profile information. In 503, the system associates the keywords with one or more retail categories of interest. In 504, the system determines a group buy preference of the user, based on the retail categories of interest.

According to another aspect, the determination module 200a may also perform a sentiment analysis of the user profile information, to determine the sentiment associated with one or more keywords in the user profile information. For example, after the detecting the keywords “baseball” and “basketball” in the user profile page 200 of FIG. 2 (see 209), the system may determine a negative sentiment associated with the keyword “baseball” (since it is directly preceded by the words “I don't like”), and a positive sentiment associated with the keyword “basketball” (since it is directly preceded with the words “I like”). The system may associate one of the keywords (which are associated with a positive sentiment) with one or more retail categories, and may determine that the group buy preference corresponds to, identifies, and/or is associated with these retail categories. Thus, the group buy transaction system recognizes that the user John Smith is more likely to have a purchase preference for products related to the sport of basketball, rather than the sport of baseball.

According to another aspect, the determination module 200a may determine the group buy preference, based at least in part on geo-location information extracted from the network-accessible social media profiles associated with the social media platform users. With reference to the user profile page 200 of FIG. 2, the identification information 201 indicates that the user has set their location to “San Jose, Calif.”. Thus, a retail category of interest for the user may be determined to be the city of San Jose, Calif., and the group buy preference of the user may identify this retail category. Thus, various products and services focused on or near the city of San Jose, Calif. and its associated surroundings, weather, conditions, popular activities, popular shopping destination, etc, may automatically be determined as a group buy preference of the user. Moreover, the system may also apply the geo-location information to modify other group buy preferences determined for the user. For example, the group buy preference for hiking may be modified to “hiking near San Jose, Calif.”, the group buy preference for Chinese cuisine may be modified to “Chinese cuisine near San Jose, Calif.”, and so forth.

The determination module 200a may determine the group buy preferences of the user using other available systems for analyzing user profile information, as understood by those skilled in the art. For example, systems exist for analyzing social media profile information of users in order to determine retail categories of interest for users (using sentiment analysis, “taste graphs” and so forth) in order to target online advertisements towards users. These systems may be utilized by the group buy system of this disclosure to determine a retail category of interest of one or more users, which is then determined by the determination module 200a to be a group buy preference of the one or more users according to the embodiments of this disclosure.

According to various exemplary embodiments, after the group buy transaction system determines one or more group buy preferences for each social media user (e.g. based on a textual analysis or a sentiment analysis of user profile information, or based on geo-location information, etc.), the system may automatically identify any common group buy preferences among a group of social media users. Thereafter, the system may proceed to automatically determine the appropriate retail providers related to the retail categories associated with the group buy preferences, as described in more detail below.

According to another exemplary embodiment, the determination module 200a may determine the group buy preference for one or more users, based at least in part on purchase history information associated with the one or more users. Purchase history information refers to any information describing purchases and transactions made by a user, and the purchase history information associated with a user may be obtained from a number of sources.

For example, purchase history information may be accessed by the determination module 200a from network-accessible social media profiles associated with the users. For instance, the social media profile page of the user may include textual information (e.g. a status message or post) indicating that the user has previously purchased a particular product from a particular retailer (e.g. a profile post stating “John Smith recently purchased the Camera STX-9000 from the online retailer ABC.com”).

As another example, purchase history information may be obtained by the determination module 200a from a user's online financial accounts, such as a user's Paypal® account, a user's digital wallet account, a user's credit/debit card account, a user's bank account, and the like. The determination module may be configured to access, via a network (e.g., the Internet), websites associated with the online financial accounts of the user, in order to access information (e.g., transaction history logs, statements, etc.) associated with the online financial accounts. The group buy system may include various security and privacy features, ensuring that the system only accesses information regarding online financial accounts after the system receives authorization from the user to access such information (e.g., the user may opt-in by providing the group buy system with login/authentication information to access the respective online financial accounts, such as a login name, password, account number, etc.).

As another example, the determination module 200a may obtain purchase history information associated with a user directly from a retailer. For example, the determination module may access a list of retailers, and, given a particular user's name, query the retailers as to whether they have any purchase history information regarding the user. The determination module 200a may narrow the list of retailers to query, based on any available information regarding the user (e.g. information based on a textual analysis or a sentiment analysis of user profile information, or based on geo-location information, or based on other obtained purchase history information, and so forth, as described in various exemplary embodiments). The group buy system may include various security and privacy features, ensuring that the system only requests a user's purchase history information from retailers after the system receives authorization from the user to access such information.

After the determination module 200a accesses the purchase history information, the determination module 200a may identify products, services, and/or retailers from the purchase history information. For example, the determination module 200a may perform a textual analysis of the purchase history information to identify one or more keywords, and associate those keywords with products, services, retailers, retail categories, etc. For example, the text from the user profile information may be compared with one or more database records (e.g., database 200c in FIG. 2) identifying plural candidate keywords and corresponding products, services, retailers, retail categories, etc. Thereafter, the determination module 200a may associate the one or more keywords with one or more products, services, retailers, retail categories, etc.

Thus, for example, if the purchase history information corresponds to a post on a social media profile page stating that “John Smith recently purchased the Camera STX-9000 from the online retailer ABC.com”, the group buy transaction system may determine that a product “Camera STX-9000” was purchase from a retailer “ABC.com”. As another example, if the purchase history information corresponds to a credit card statement from an online financial account of the user, which describes a transaction such as “$500 Delta Tennis Racquet Rick's Sporting Goods”, then the system may determine that a product “Delta Tennis Racquet” was purchase from the retailer “Rick's Sporting Goods”. As another example, if the purchase history information corresponds to a transaction history from a Paypal® account of the user, which lists a transaction such as “$50 Peacecraft 2 Video Game—MJ's Video Game Store”, then the system may determine that a product “Peacecraft 2 Video Game” was purchased from the retailer “MJ's Video Game Store”. The determination module 200a may treat the identified products, services, or retailers as a “retail categories of interest” as described throughout this disclosure, and the determination module 200a may determine that the group buy preference of the user corresponds to, identifies, and/or is associated with the aforementioned retail categories of interest (i.e., products, services, or retailers, such as “Camera STX-9000”, “Rick's Sporting Goods”, etc.).

According to an aspect, if the determination module 200a identifies a retailer based on the purchase history information, the determination module may communicate directly with the identified retailer, in order to obtain additional purchase history information associated with a user. The group buy system may include various security and privacy features, ensuring that the system only requests a user's purchase history information from retailers after the system receives authorization from the user to access such information.

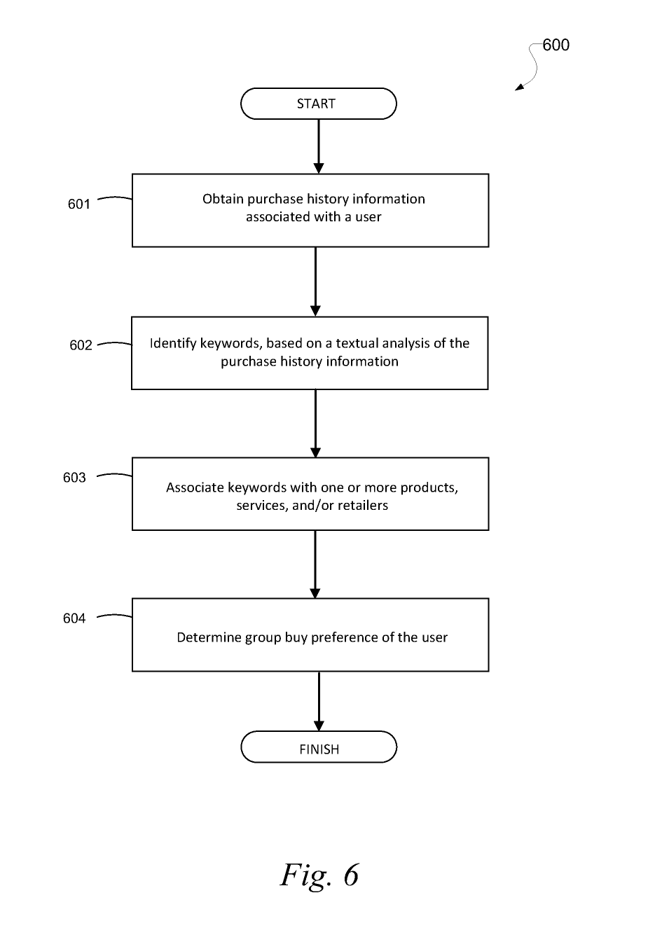

Turning now to FIG. 6, flowchart 600 illustrates an example method 600, according to various embodiments described in more detail below. The method 600 may at least partially be performed by a group buy transaction system (or a similarly configured group buy transaction apparatus), such as group buy transaction system 200 illustrated in FIG. 2. In 601, the system obtains purchase history information associated with a user. In 602, the system identifies keywords, based on a textual analysis of the purchase history information. In 603, the system associates the keywords with one or more products, services, and/or retailers. In 604, the system determines a group buy preference of the user, based on the aforementioned products, services, and/or retailers.

According to various exemplary embodiments, after the group buy transaction system determines one or more group buy preferences for each user (e.g., based on purchase history information associated with each user), the system may automatically identify any common group buy preferences among a group of users. In this way, the system determines a group of users having a group buy preference in the form of a shared purchase history. For example, all the users in the group may have purchased the same product (e.g., “Delta Tennis Racquet”, “Peacecraft 2 Video Game”). As another example, all the users in the group may have purchase products from a particular retailer (e.g. “Rick's Sporting Goods”). Thereafter, the system may proceed to automatically determine the appropriate retail providers related to the retail categories associated with the group buy preferences, as described in more detail below.

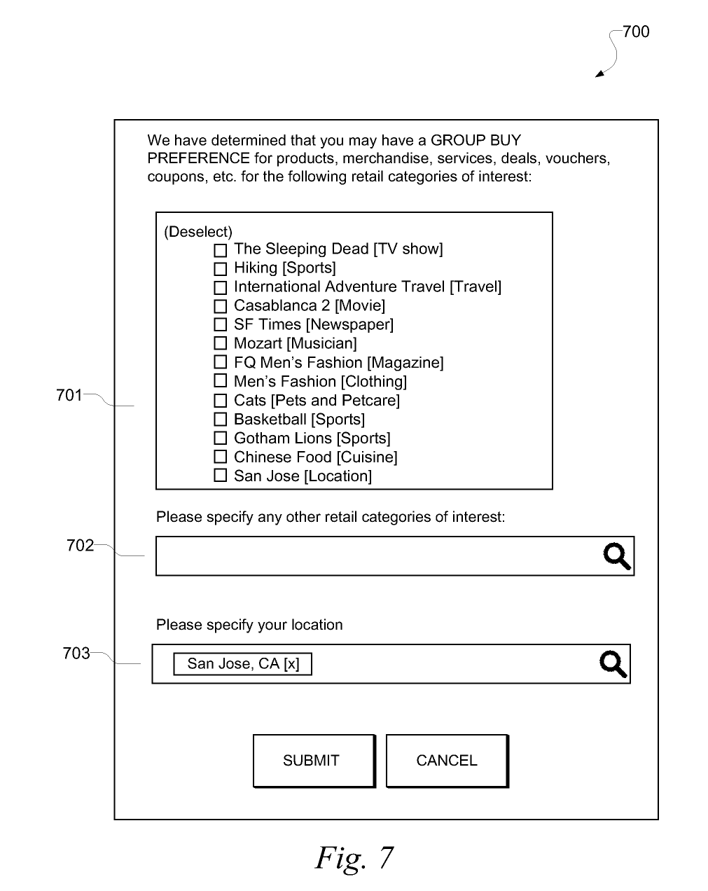

According to various exemplary embodiments, after the group buy transaction system determines the group buy preference for one or more users, the group buy transaction system may inform each user about their determined group buy preferences, and permit the user to modify the group buy preferences (e.g., before the system attempts to determine an appropriate retail provider). FIG. 7 illustrates an example portion of a web-accessible user interface 700 hosted by an application server (e.g. a group buy transaction device), wherein the user interface displays retail categories of interest (701) corresponding to group buy preferences determined to be applicable to the user John Smith, based on the profile page of the user illustrated in FIG. 4. The retail categories are displayed along with a corresponding domain (e.g. TV Show, Sports, etc.). The user may deselect any of the retail categories. Moreover, the user may also search for and/or specify other retail categories using the search window 702. The user interface also displays the determined location of the user (e.g. determined based on the location information 401 from the user's profile page 400) in the location window 703, and permits the user to specify a different location. After the user selects the “submit” button of the user interface 700, the system collects the finalized group buy preferences for several social media users, automatically determines any common group buy preference among the several social media users, and then proceeds to automatically determine the appropriate retail providers related to the retail categories associated with the common group buy preference.

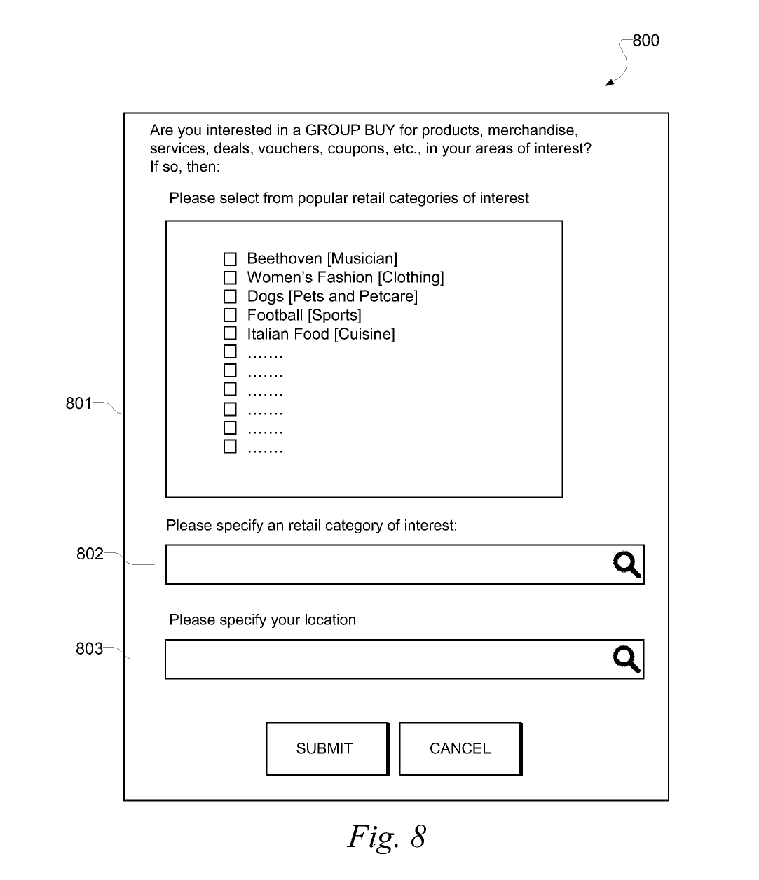

In another exemplary embodiment, the determination module 200a may also determine the group buy preference of a user based on responses from the user to electronic questionnaires or surveys. FIG. 8 illustrates an example portion of a web-accessible user interface 8800 hosted by an application server (e.g. a group buy transaction device), wherein the user interface permits a user to select one or more retail categories of interest, e.g. from among popular retail categories, in area 801. Moreover, the user may also search for and/or specify other retail categories of interest in the search window area 802. The user interface 800 also permits the user to specify a location in location area 803. After the user selects the “submit” button of the user interface 800, the system characterizes the retail categories of interest as group buy preferences (or associates the retail categories of interest with group buy preferences), collects the finalized group buy preferences for several social media users, automatically determines any common group buy preference among the several social media users, and then proceeds to automatically determine the appropriate retail providers related to the retail categories associated with the common group buy preference.

The user interface 800 of FIG. 8 may be hosted by a group buy transaction server, and accessible via browser application operating on a client (e.g. client 110 or 112 in FIG. 1). The user interface 800 may be accessed by a user via the social media website, and thus may correspond to an online survey request transmitted to the network-accessible social media profiles associated with one or more social media platform users. The determination module 200a may receive plural survey responses via the network-accessible social media profiles associated with the social media platform users; and may determine the group buy preference as one or more retail categories of interest specified in each of the plural survey responses.

The group of social media users analyzed by the group buy transaction system of this disclosure may be defined broadly or narrowly. For example, the system may analyze the social media profiles of all the users of the social media website on a recurring basis, in order to determine one or more groups of users that have common group buy preference. As another example, the system may analyze all the social media profiles of users that have a specific relationship with each other (friends, followers, associates, etc.). As another example, the system may analyze all the social media profiles of users having a certain characteristics in common, such as users having a common geographic location, common educational background, common employer, etc., based on the user profile information of the user.

Alternatively, according to various exemplary embodiments, the system may display a user interface to a user in order to receive a user specification of others (e.g. the user's friends) with which to form a group. After the user specifies the group, the system may determine if there is a common group buy preference for the group. Alternatively, according to another exemplary embodiment, the user may first select a retail category of interest/group buy preference, and then invite others to join the group to participate in a request for a group buy deal based on the selected retail category of interest. That is, the group buy system allows the user to invite their friends to participate in a request for a group buy deal. Many benefits may be realized by this approach, since individuals may have the best knowledge of the purchase preferences and retail categories of interest of their friends.

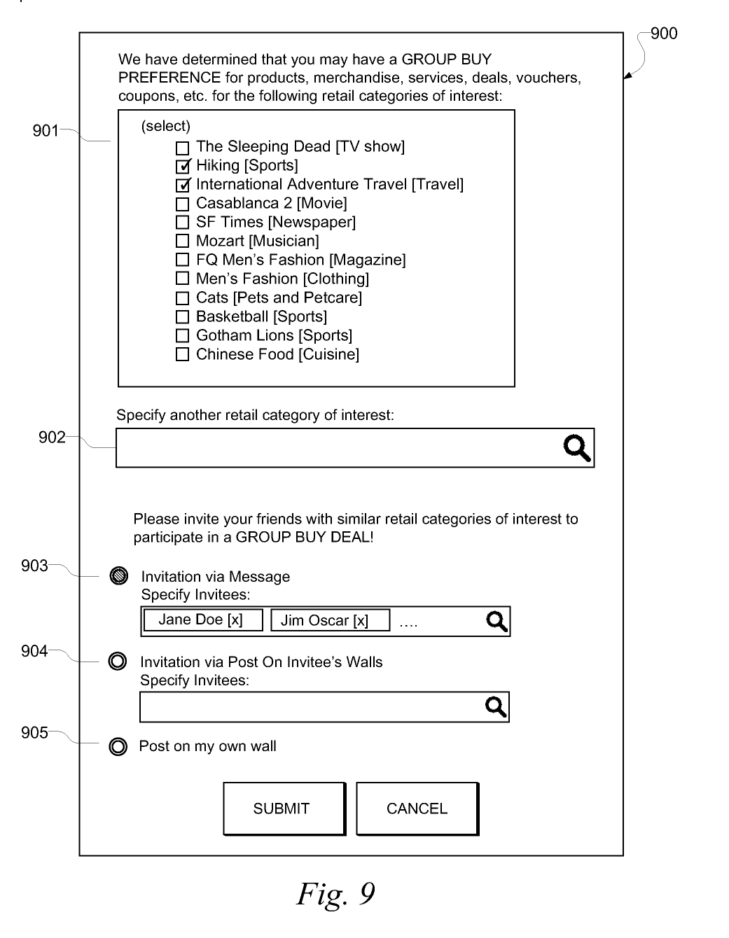

FIG. 9 illustrates an example portion of a web-accessible user interface 900 hosted by an application server, which displays retail categories of interest corresponding to group buy preferences determined to be applicable to user in area 901, and may allow the user to add other retail categories of interest in area 902, similar to the user interface 700 of FIG. 7. Moreover, the user interface 900 allows the user to select one or more of the determined retail categories in area 901 (e.g., Hiking, International Adventure Travel), and to select other individuals to be included in a request for a group buy deal based on the selected group buy preferences (i.e., Hiking, International Adventure Travel).

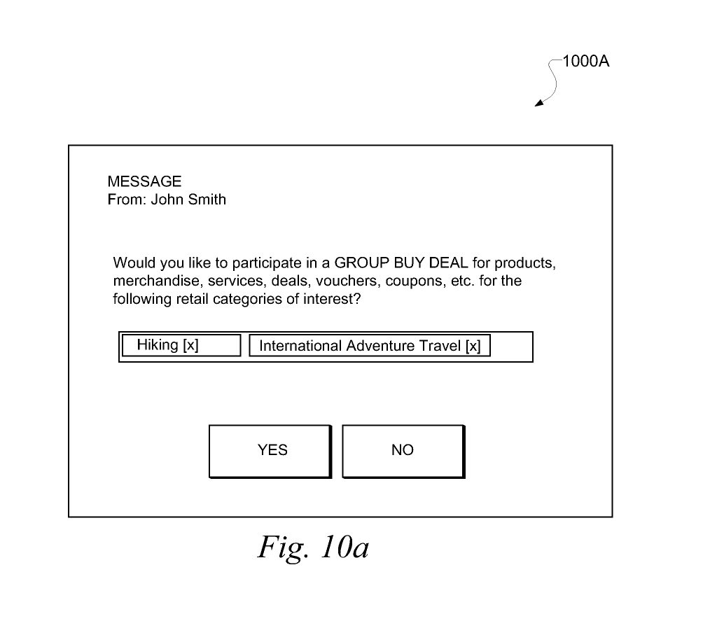

The invitation may be transmitted as a private message to the specified users, using the user interface features in area 903, and an example of such a message is illustrated in FIG. 10a. The invitation may be transmitted as a post on the profile pages of the selected users, using the user interface features in area 904, and an example of such a post on a friend's profile page is illustrated in FIG. 10b. The invitation may also be posted on the original user's own wall (and thus viewable by all of the user's friends or followers on the social network), via the user interface features in area 905, and an example of such a post is illustrated in FIG. 10c. Based on the responses to the invitations, (e.g. the invitees selecting either “Yes” or “No”, selecting “like”, etc.), the determination module 1200a determines a selected retail category of interest (e.g. hiking) of the original user John Smith (e.g. see FIG. 9) as a group buy preference of the group of users that includes the original user John Smith, and any other invitees that accepted John Smith's invitation with respect to the selected retail category of interest (i.e. hiking). The system then proceeds to automatically determine the appropriate retail providers corresponding to the retail category associated with the common group buy preference, as described in greater detail below.

While the user interface 900 of FIG. 9 illustrates retail categories of interest corresponding to group buy preferences automatically determined to be applicable to the user, based on user profile information extracted from the profile page of the user (e.g. the profile page of John Smith seen in FIG. 4), the user interface may also be configured to determine the group buy preference of a user, based on responses from the user to electronic questionnaires or surveys.

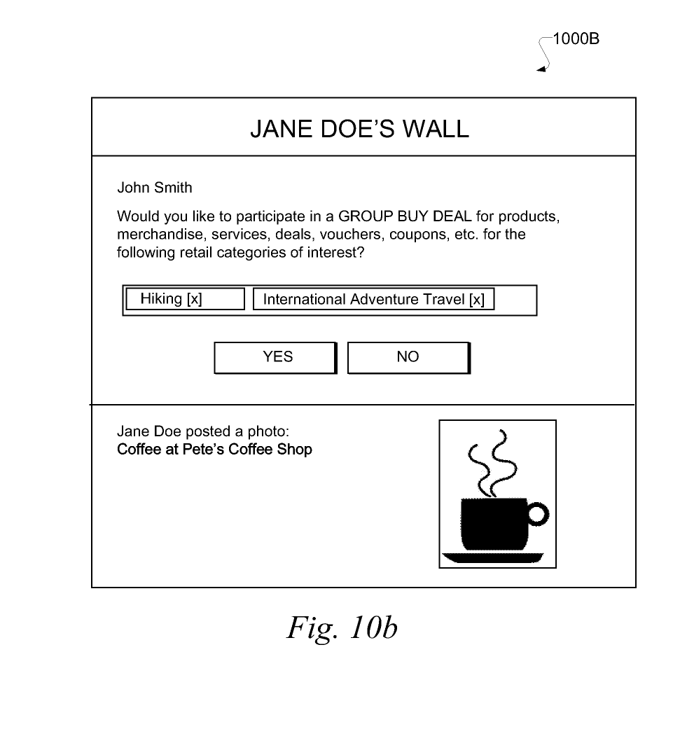

Continuing from the discussion of FIG. 9, FIG. 11 illustrates an example portion of a web-accessible user interface 1100 hosted by an group buy transaction server, wherein the user interface 1100 permits a user to select one or more retail categories of interest corresponding to group buy preferences (similar to the user interface 800 of FIG. 8), and allows the user to select other individuals to be included in a request for a group buy deal based on the one or more of the selected group buy preferences (similar to the user interface 900 of FIG. 9). Based on the responses to the invitations, (e.g. the invitees selecting either “Yes” or “No”, selecting “like”, etc.), the determination module 200a determines a selected retail category of interest (e.g. Beethoven) of the original user John Smith (e.g. see FIG. 11) as a group buy preference of the group of users that includes the original user John Smith, and any other invitees that accepted John Smith's invitation with respect to the selected retail category of interest (i.e. Beethoven). The system then proceeds to automatically determine the appropriate retail providers corresponding to the retail category associated with the common group buy preference.

### Determination of Retailer

After the determination module 200a of the group buy transaction system determines a group buy preference (identifying a retail category of interest) corresponding to a group of social media platform users, the request generation module 200b automatically determines a provider (e.g. retailer, manufacturer, merchant, etc.) of products or services corresponding to the retail category associated with the determined group buy preference. For example, if the group buy preference corresponds to or identifies the retail category of hiking equipment, then the determination module automatically determines one or more retailers of hiking equipment, whereas if the group buy preference corresponds to or identifies the retail category of Chinese cuisine, then the determination module automatically determines one or more Chinese restaurants.

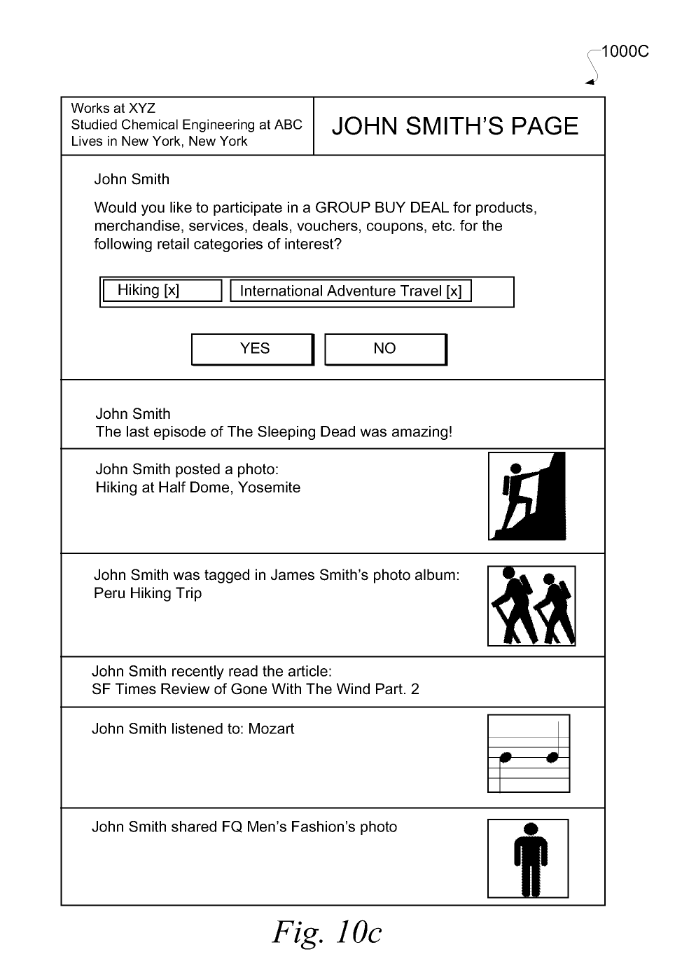

The request generation module 200b may determine the appropriate retailer by referring to a database of preferences and corresponding retailers. For example, the database 200c (see FIG. 2) may include one or more database records that identify retail categories of interest, and retailers that correspond to each of the retail categories of interest. FIG. 12 illustrates an example of a database record 1200 that lists plural candidate retail categories of interest (e.g. The Sleeping Dead, Hiking, Mozart), optional high-level domain classification of the retail category of interest (e.g. T.V. Show, Sports, Musician), and plural retailers corresponding to each of the retail categories of interest. Such database records may be assembled by the retailers themselves, who provide database records that identify themselves as the providers of certain products and associate themselves with certain keywords (e.g., for the purposes of placing targeted advertisements, etc.).

The determined providers may also be filtered based on geo-location information. For example, since the user profile information from the profile page of John Smith (see FIG. 2) indicates that the user is located in San Jose, Calif., the system may filter the list of determined providers to that area. As another example, geo-location information (based on GPS co-ordinates, wifi or wireless strength, etc.) may be obtained from a device or Smartphone of the user and may be used to identify the current location of the user, and the providers may be filtered accordingly.

According to an aspect, the request generation module 200b may determine the retailer based at least in part on purchase history information associated with one or more users in the group of social media platform users. For example, in a manner similar to various exemplary embodiments described above, the request generation module 200b may obtain the purchase history information associated with one or more users from any number of sources (e.g., from social media profiles associated with the users, from online financial accounts, etc. perform a textual analysis of the purchase history information to identify one or more keywords, and associate those keywords with one or more retailers.

The request generation module 200b may rank the relevant retailers based on, for example, how many users in the group of social media platform users have purchased from the retailer before, and/or how frequently they have purchased from the retailer. For example, suppose a group of social media users has a group buy preference for handbags, and the purchase history information for the group of social media users indicates that a large proportion of the group of social media users has previously purchased numerous items from a particular handbag retailer “Hem”, indicating a loyalty towards this retailer. The request generation module 200b may assign a high ranking to this retailer, and determine that this retailer should be approached in order to solicit group buy deals, since it may be more likely that the retailer will offer competitive deals to loyal customers, and since there is a greater likelihood of conversion on the part of the users. As another example, suppose a group of social media users has a group buy preference for guitars, and the purchase history information for the group of social media users indicates that a no one in the group of social media users has previously purchased items from a particular guitar manufacturer “Gem”, indicating that perhaps “Gem” is a new business. The request generation module 200b may assign a high ranking to this retailer, and determine that this retailer should be approached in order to solicit group buy deals, since it may be more likely that a new business is willing to provide better deals to attract and retain new customers.

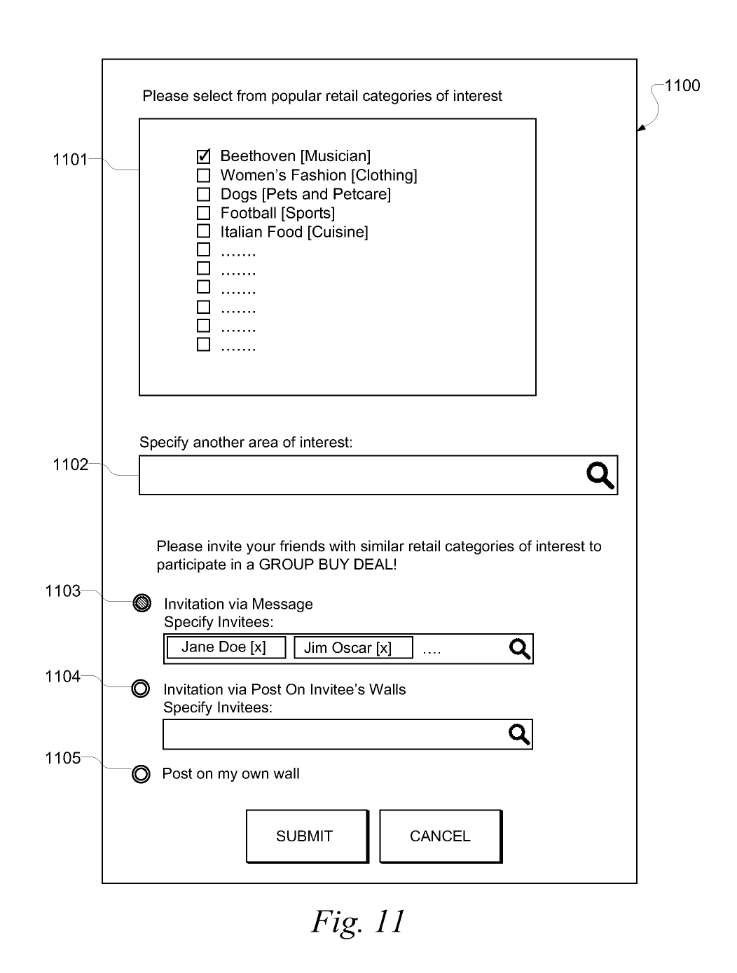

According to an aspect, the request generation module 200b may determine the providers based on user input. FIG. 13 illustrates an example portion of a web-accessible user interface 1300 hosted by a group buy transaction server, wherein the user interface allows the user to select one or more retailers corresponding to a particular retail category of interest. For example, the user interface 1300 may display suggested retailers 1301 for the particular retail category of interest, wherein the retailers are determined based on database records (see FIG. 12). The user may also specify a retailer, in user interface area 1302. Further, the list of suggested retailers may be filtered based on location information of the user, as described above. After the user selects the “submit” button of FIG. 13, the system finalizes the determination of the provider, and proceeds to generate the group buy deal request.

### Generation and Transmission of Group Buy Deal Request

After the request generation module 200b determines a group buy preference corresponding to a group of social media platform users, and determines a retailer corresponding to the retail category associated with the determined group buy preference, the request generation module generates a request for a group buy deal corresponding to the determined group buy preference, and transmits the request to the retailer.

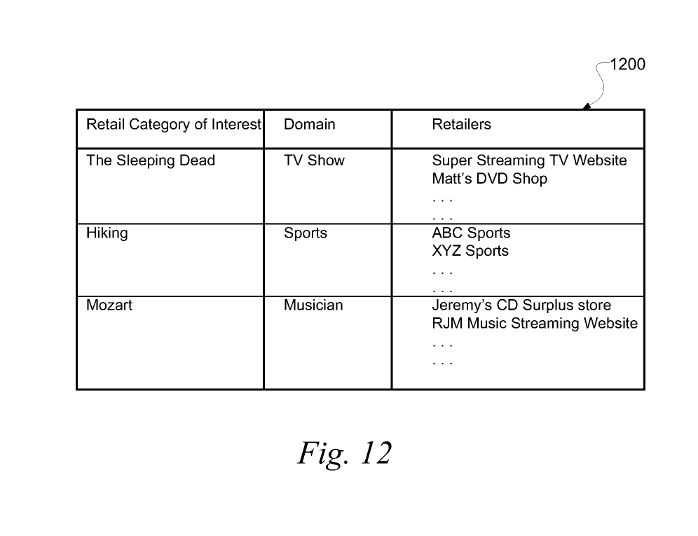

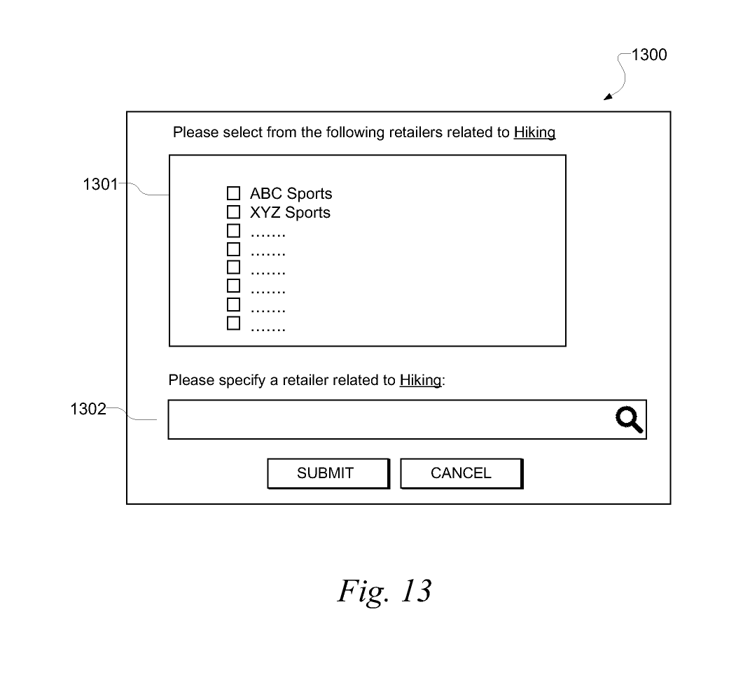

FIG. 14 illustrates an example of a group deal request (in the form of an email message) generated by an application server, and transmitted by the application server to a retailer ABC sports, with a request for a group buy deal for the retail category of interest of hiking. If the retailer accepts the request, the retailer can submit a group buy deal offer (e.g. by reply message) to the group buy transaction server, which then transmits the group deal offer to each of the individual members of the group. FIG. 15 illustrates an example of a message transmitted from a group buy transaction server to a user, wherein the message describes details of a group buy deal. If all the users in the group accept the deal, the group buy system provides the group members with information about the retailer and vice versa, in order to complete the purchase.

The request may include biographical and other information regarding the users, which may be used by the retailer for future marketing efforts. Moreover, the request may include purchase history information regarding the users, which may facilitate the offering of group buy deals from the retailer. For example, if the purchase history information indicates that the group of users are loyal customers of the retailer, then the retailer may offer more competitive deals to these loyal customers. As another example, if the purchase history information indicates that none of the users have ever interacted with the retailer before (e.g., because the retailer is a new business), then the retailer may offer more competitive deals to attract and retain new customers.

### Purchase Codes

According to another exemplary embodiment of this disclosure, a group buy transaction system is configured to process a group buy transaction for one or more users, based on one or more purchase codes distributed to the one or more users.

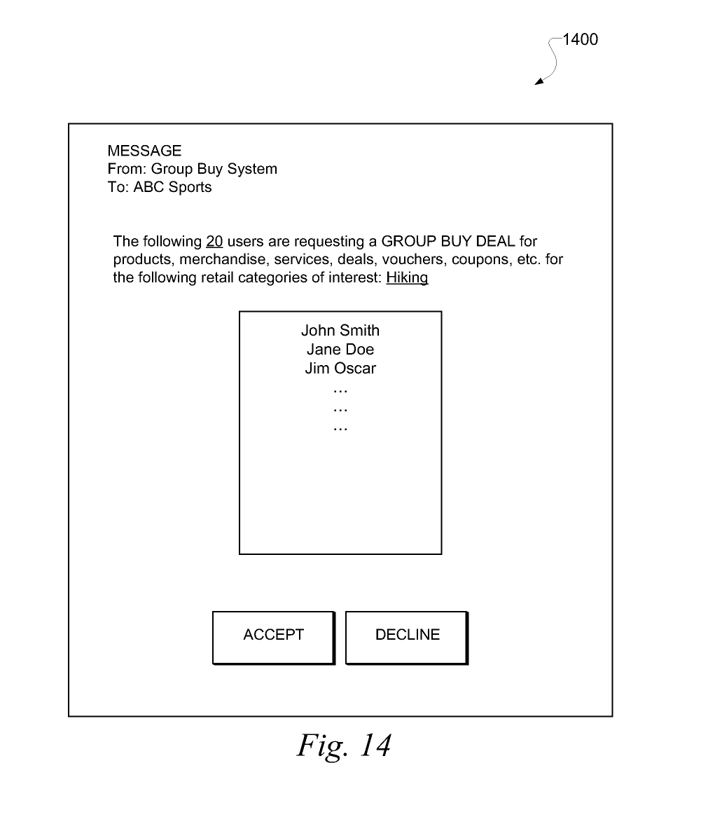

As illustrated in FIG. 16, a group buy transaction system 1600 according to various exemplary embodiments includes a purchase order module 1600a, a code management module 1600b, a determination module 1600c, and a database 1600d. The modules of the group buy transaction system 1600 may be implemented on a single device, such as a group buy transaction server or group buy transaction device, or on separate devices interconnected via a network. The aforementioned group buy transaction server or group buy transaction device may correspond to, for example, one of the client machines (e.g. 110, 112) or application server(s) 118 illustrated in FIG. 1.

The purchase order module 1600a is configured to process purchase orders for products received from one or more users. For example, an e-commerce website may post a product item (e.g. a pair of shoes) for sale at a particular retail price (e.g. $50), and the purchase order module 1600a is configured to receive, via the e-commerce website, a purchase order for a certain quantity of the product item at the particular retail price. The e-commerce website may also post a group buy offer corresponding to the product item, where the group buy offer identifies a group buy discount price and corresponding group buy quantity threshold. For example, the group buy offer may state that 10 pairs of shoes may be purchased for only $200.

Suppose a first user accessing the e-commerce website via a network (such as the Internet) submits a purchase order to the e-commerce website for 2 pairs of shoes for $100, where the full retail price of each pair of shoes is $50. Thus, this first purchase order is associated with a first quantity (2) of a specific product item (pair of shoes) for a specific price ($100). The aforementioned e-commerce website may be hosted on the application server(s) 118 (see. FIG. 1), and the first purchase order may be received by the purchase order module 1600a via a network (e.g. the Internet), from a client device (e.g. 118 in FIG. 1) associated with a first user. The purchase order module 1600a processes the first purchase order for the first user (e.g. receiving and verifying user information and payment details), thereby completing the sale for 2 pairs of shoes for $100, where the full retail price of each pair of shoes is $50.

According to another aspect, the user may submit the purchase order in a physical store (e.g. via a digital wallet), and a local machine (e.g., kiosk, computer terminal, etc.) in the store may transmit the purchase order to the purchase order module 1600a, or alternatively the purchase order module 1600a may be implemented on the local machine.

Thereafter, the code management module 1600b generates a unique purchase code (e.g. “XYZWG”) and associates the purchase code with the first purchase order (e.g. the purchase order from the first user for 2 pairs of shoes for $100). The unique purchase code is also associated by the code management module 1600b with the group buy offer corresponding to the specific product that is the subject of the first purchase order (e.g. the group buy offer of 10 pairs of shoes for $200). The unique purchase code may also be associated by the code management module 1600b with an expiration date, which may be a predetermined time period (e.g. a week) after the time of the first purchase order.

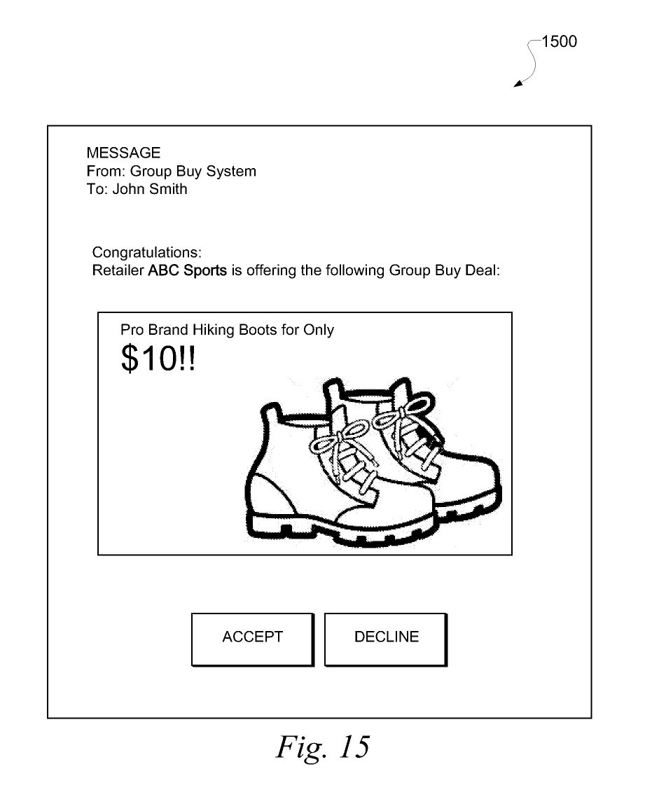

The code management module 1600b may create a database entry in database 1600d identifying the unique purchase code, as well as information regarding the associated purchase order, the associated group buy offer, and the associated expiration date. For example, FIG. 17 illustrates an example database table 1700 that identifies the unique purchase code, as well as information regarding the associated product and purchase order (e.g. user, quantity, price, etc.), the associated expiration date, and the associated group buy offer (i.e. group buy quantity threshold, group buy discount price). After the purchase order module 1600a processes the first purchase order for the first user, the appropriate purchase code is provided to the user by either the code management module 1600b or the purchase order module 1600a. For example, the purchase code may be transmitted to a client device associated with the first user via a network.

Thereafter, the user may share the purchase code with other users. For example, the user may transmit the purchase code to their friends via email, text message, SMS message, instant message, chat, etc. As another example, the user may share the purchase code with their friends via the respective social media profiles of the users on an online social network website or other online media. The user may transmit the purchase code to other users using various methods understood by those skilled in the art.

Thereafter, the other users that possess the purchase code may execute their own purchase orders using the purchase code. For example, the others users may access the aforementioned e-commerce website, and complete purchase orders in a user interface screen of a webpage hosted by a server. The user interface screen may include a feature whereby the user may identify the purchase code in connection with the new purchase order. The new purchase order and identified purchase code may be transmitted to the purchase order module 1600a, and the code management module 1600b then associates information regarding the new purchase orders with the purchase code (and thereby also associates the information regarding the new purchase orders with the information regarding the previous purchase orders that are already associated with the same purchase code).

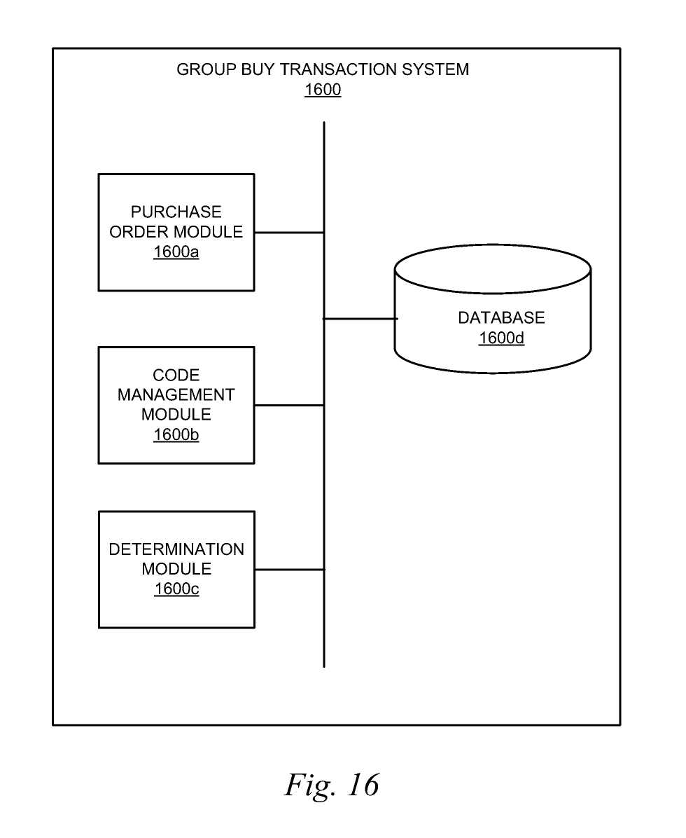

Referring to the previous example described with reference to FIG. 17, suppose a second user receives the purchase code “XYZWG” from the first user, and completes a purchase order for 8 pairs of shoes for $400 (since the retail price for each pair of shoes is $50). Since the second user supplies the purchase code “XYZWG” when completing the second purchase order, information regarding the second purchase order is associated with the information regarding the purchase code “XYZWG” and the first order, included in the database 1600d. For example, FIG. 18 illustrates a database entry 1800 similar to the database entry 1700 illustrated in FIG. 17, except information regarding the new purchase order has been associated by the code management module 1600b with the information regarding the purchase code “XYZWG” and the first order. While this example has described a first and a second purchase order associated with the purchase code “XYZWG”, it should be understood that any plural number of purchase orders for one or more users may be associated with a purchase code, in accordance with the aspects of this exemplary embodiment.

The determination module 1600c is configured to determine that multiple purchase orders (associated with a certain purchase code) qualify for a group buy offer (associated with the purchase code). That is, the determination module determines that that a combination of received purchase offers that identify a certain purchase code qualify for a group buy offer associated with the purchase code, by comparing the sum of the quantities of the purchase orders against the group buy threshold of the group buy offer. If the sum of the quantities of the purchase orders is equal to or greater than the group buy threshold of the group buy offer, then the users corresponding to these purchase orders are entitled to the group buy price.

Referring to the previous example described with reference to FIG. 18, the determination module 1600c may access the database entry 1800, determine that the sum of the quantities of the purchase orders (i.e. 2+8) is equal to or greater than the group buy threshold (10) of the group buy offer, and thus the users (user1, user 2) corresponding to these purchase orders are entitled to the group buy price ($200 for 10 pairs of shoes).

The determination module 1600c may determine refund amounts to be refunded to each of the users that submitted the purchase orders associated with the group buy offer. For example, in FIG. 18, the determination module may divide the group buy discount price by the group buy threshold, to determine a group unit purchase price (e.g. $200/10=$20 per unit). For each associated purchase order, the determination module then multiplies the group unit purchase price by the specified quantity, in order to determine a revised purchase order purchase price. For example, for the first purchase order corresponding to the user 1, group unit purchase price [$20 per unit]×specified quantity [2 units]=the revised purchase order purchase price [$40]. For each associated purchase order, the determination module 1600c then subtracts the revised purchase order purchase price from the actual recorded purchase price, in order to determine the refund amount. For example, for the first purchase order corresponding to the user 1, actual recorded purchase price [$100]−revised purchase order purchase price [$40]=refund amount [$60]. The determination module performs these processes for each of the purchase orders, and the purchase order module 1600a then provides the appropriate refunds to the appropriate users (e.g. refunds to a user financial account).

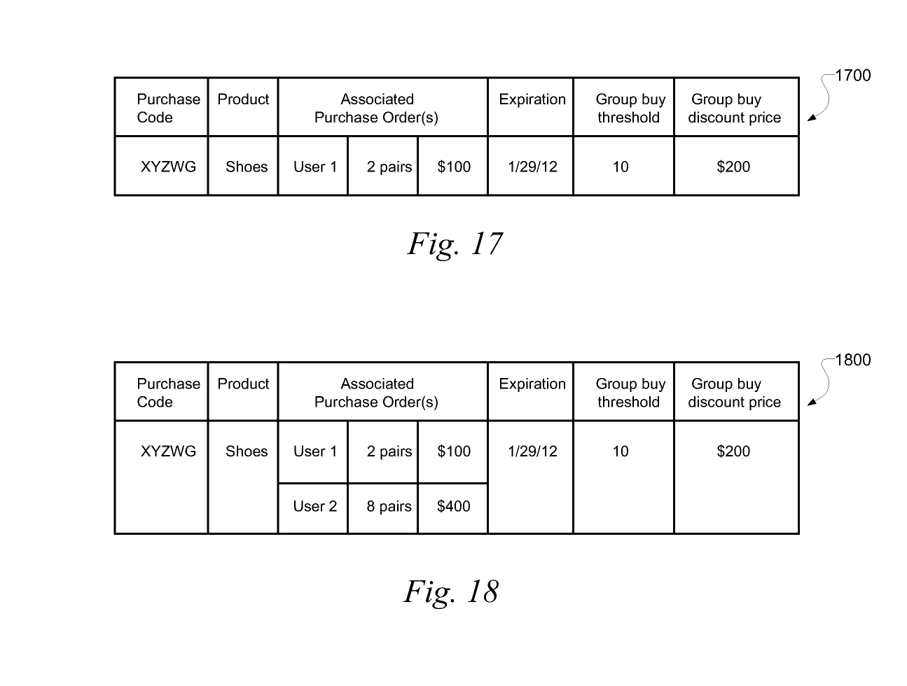

According to another aspect, the purchase code is associated with a multi-tiered group buy offer. For example, the group buy offer may include multiple group buy thresholds and multiple corresponding group buy prices. For example, FIG. 19 illustrates a database table 1900 similar to the database table 1700 illustrated in FIG. 17, except that a multi-tiered group buy offer is included (e.g. group buy threshold 1 and corresponding group buy price 1, group buy threshold 2 and corresponding group buy price 2, group buy threshold 3 and corresponding group buy price 3). The group buy processing system described above may process purchase orders in the manner described above, based on multiple group buy thresholds. For example, the determination module 1600c may determine whether a combination of purchase orders satisfies each of the group buy thresholds, in accordance with various aspects described above. According to an aspect, if the determination module 1600c determines that the combination of the purchase orders satisfies more than one of the group buy thresholds, then the determination module 1600c determines that the purchase orders qualify for the group buy deal and group buy price corresponding to the highest threshold, and applies this group buy deal to the combination of the purchase orders. For example, if the determination module 1600c determines that a combination of purchase orders having a total quantity of 20 satisfies group buy threshold 1, group buy threshold 2 and group buy threshold 3 as illustrated in FIG. 19, then the determination module 1600c determines that the purchase orders qualify for the group buy deal and group buy price corresponding to the highest threshold (i.e. group buy price of $300 corresponding to threshold 3 in FIG. 19), and the determination module 1600c applies this group buy deal to the combination of the purchase orders. In this example, since the total quantity of the combination of purchase orders (i.e. 20) is greater than the highest group buy threshold of 18, the group buy deal may apply to 18 items of the purchase order, with the remaining quantity of the items in the purchase order being assessed at retail price, for example.

The purchase codes described in various exemplary embodiments may represent considerable improvements over conventional coupons. For example, conventional coupons are static in nature, and may include restrictions with respect to how many times the coupon may be used or the quantity of products to which the coupon may apply. In contrast, the purchase codes of various exemplary embodiments are dynamic in nature, and may be used by any number of users any number of times for the purchase of any number of products. Further, whereas conventional coupons do not keep track of quantity-based discount relationships with users, the purchase codes described herein are associated with group buy offers and information tracking the history of purchase orders related to group buy offers. Moreover, while conventional coupons are associated with just one type of discount, the purchase codes described herein may be associated with multi-tiered discounts that provide more than one group buy discount option for the same product.

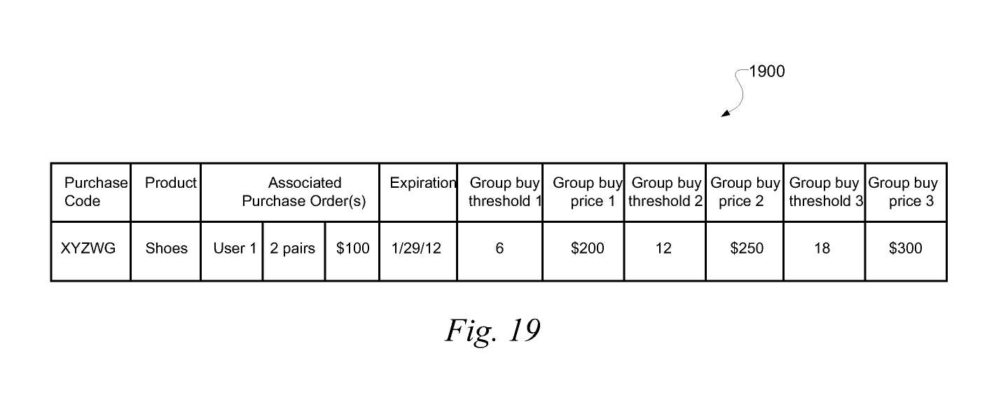

Turning now to FIG. 20, a flowchart illustrates an example method 2000, according to various embodiments. The example method 2000 may be performed by, for example, a group buy transaction system or group buy transaction device (see FIG. 16). In step 2001, the system processes a first purchase order associated with a first quantity of a specific product item, the purchase order being received from a client device via a network. In step 2002, the system generates a purchase code associated with the first purchase order, the purchase code being associated with a group buy discount price and corresponding group buy quantity. The system may also transmit the purchase code to the client device. In step 2003, the system processes a second purchase order associated with a second quantity of the specific product item, the second purchase order identifying the purchase code. In step 2004, the system determines that the first and second purchase orders qualify for the group buy discount price associated with the purchase code.

According to various exemplary embodiments, as each purchase order identifying the purchase code is received, the purchase order module 1600a processes each purchase order identifying the purchase code at the full retail price. The group buy deal will only be applied after the group buy threshold of the group buy deal has been satisfied. That is, after receiving an “n-th” a purchase order identifying the purchase code (wherein the combination of all the “n” received purchase orders identifying the purchase code includes a total quantity that satisfies the group buy threshold quantity), the system processes refunds for each of the purchase orders.

For example, suppose item A has a normal retail price of $100, and suppose a group buy deal with a purchase code XSWD has a group buy quantity threshold set at 5 items and a group buy discount price of $350 (or $70 per item, representing a discount of $30 per item). Either the same user can do repetitive purchases with purchase code XSWD for the same item A, or he can share the code with his friends who can buy the same item A with purchase code XSWD. Suppose the system receives 4 purchase orders with the purchase code XSWD, each for 1 unit of item A. The price of 1 unit of item A will still be assessed at $100 for each of these purchase orders. Now suppose someone (e.g. the original user, or one of his friends) submits a 5th purchase order for 1 unit of item A with the purchase code XSWD. The 5^{th} order for the 5^{th} item may also be assessed by the system at the full retail price of $100. Only at this point is the multi-quantity discount is triggered at the system. Accordingly, since each of the purchase orders were charged at the full retail price of $100 per unit, a refund of $30 will be assessed by the system for each of the purchase orders. Thus, the user(s) will not only get the discount for the 5th item, but also gets a refund for all the 4 items bough before, in the form of refunds applied to their accounts. Therefore, once the user(s) reach the group buy quantity threshold, they receive discounts for all the relevant items purchased previously. In the exemplary case of 5 users buying with the same purchase code, all the 5 different users get refund back to their account when the 5th user buys the item.

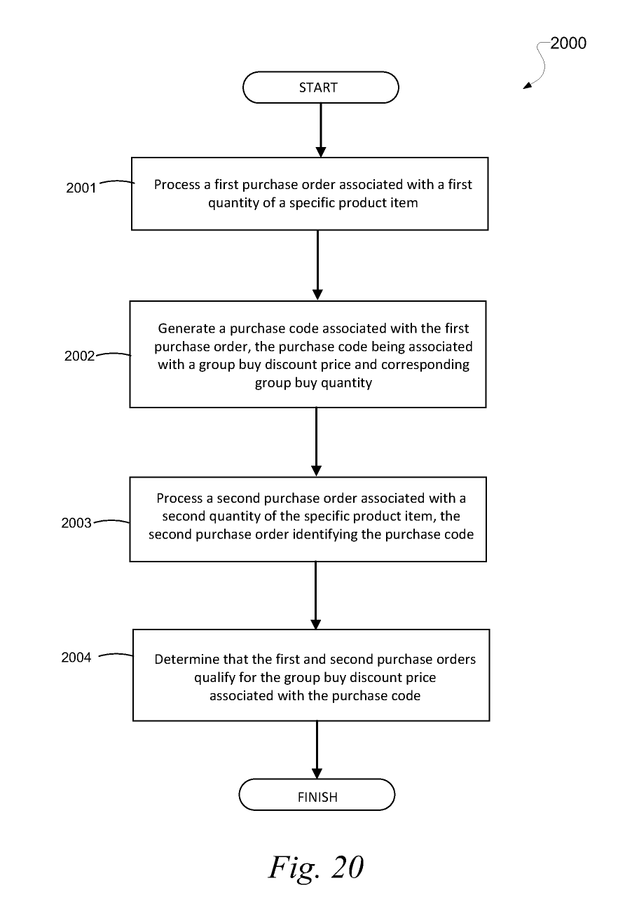

Turning now to FIG. 21, a flowchart illustrates an example method 2100, according to various embodiments. The example method 2100 may be performed by, for example, a group buy transaction system or group buy transaction device (see FIG. 16). In step 2101, the system receives a purchase order for quantity X of item A, the purchase order identifying a particular purchase code. In step 2102, the system processes the purchase order for quantity X of item A (received at step 2101) at the normal price (e.g. non-discounted price, full retail price, etc.) of item A. In step 2103, the system determines whether a predetermined quantity threshold associated with the purchase code has been reached. If no (step 2103, N), then the flow returns to step 2101, and more purchase orders for item A identifying the purchase code are received, wherein each of the additional purchase orders may be for the same quantity X or a different quantity. If yes (step 2103, Y), then in step 2104, the system processes a group buy discount associated with the purchase code, and distributes the discount as refunds applied to each of the previously received purchase orders. As described above in various exemplary embodiments, the amounts of the refunds applied to each of the previously received purchase orders may be determined by the system, based on the quantity of items requested in each of the previously received purchase orders.

According to another exemplary embodiment, a group buy transaction system is configured to process a quote for a group buy deal submitted by a group of users. Thus, a group of users may “negotiate” a price for a specific quantity of a specific product, by providing a price quote.

Referring back to FIG. 16, the purchase order module 1600a may be configured to receive a group buy purchase quote associated with a first price and a first quantity of a specific product item, the purchase order being received from a device via a network.

For example, a group of users may enter a physical store and submit a group buy purchase quote of $320 for 8 units of the ABC game console. Thus, the group buy purchase quote is associated with a first price ($320) and a first quantity (8) of a specific product item (ABC game console). A member of the group may submit the group buy purchase quote at a local machine (e.g., kiosk, computer terminal, etc.) in the store. The in-store terminal may transmit the group buy purchase quote to the purchase order module 1600a, or alternatively the purchase order module 1600a may be implemented on the in-store terminal. In turn, the purchase order module 1600a may transmit the group buy purchase quote to the determination module 1600c.

Alternatively, one or more members of the group may access an e-commerce website corresponding to the store via a network (such as the Internet), and submit the group buy purchase quote to the e-commerce website. The aforementioned e-commerce website may be hosted on the application server(s) 118 (see. FIG. 1), and the group buy purchase quote may be received from a client device (e.g. 118 in FIG. 1) associated with a first user via a network (e.g. the Internet).

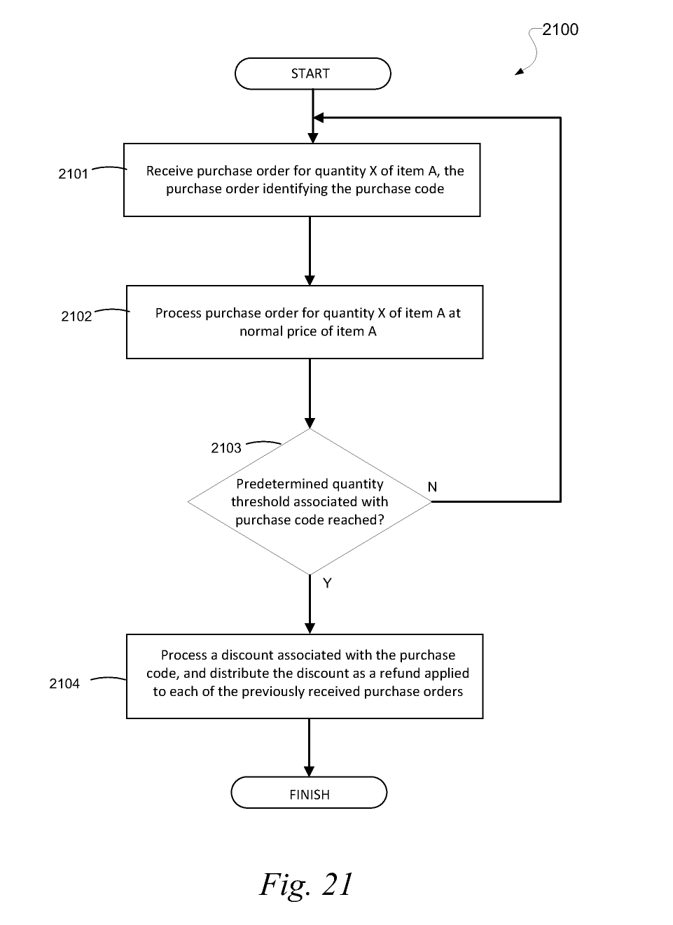

The determination module 1600c may compare the received group buy purchase quote with a predetermined purchase price associated with the first quantity of the specific product item. For example, suppose the group buy purchase quote is associated with a first price ($320) and a first quantity (8) of a specific product item (ABC game console). The database 1600d may store database entries for a specific product that lists several predetermined quantity thresholds and several corresponding predetermined price thresholds. This information may be kept secret from the group of users, for example. FIG. 22 illustrates an example of such a database table 2200 for the ABC game console product, wherein the predetermined quantity threshold of 8 corresponds to the predetermined price threshold of $300, for example. The determination module 1600c may update the appropriate database entry with information regarding the group buy purchase quote (e.g. quoted quantity of 6 units and quoted price of $320), as see in FIG. 22. In the example of FIG. 22, the determination module may compare the received group buy purchase quote (e.g. $320 for 8 units) with a predetermined purchase price (e.g. $300) associated with the first quantity (e.g. 8 units) of the specific product item (ABC game console).

If the quoted priced in the group buy purchase quote is equal to or greater than the predetermined threshold of the corresponding quantity, then the system may determine that the group buy purchase quote qualifies for a group buy deal, based on the current terms of the group buy purchase quote. With reference to the example of FIG. 22, the determination module may determine that the group buy purchase quote of $320 for 8 units is greater than the predetermined threshold of $300 for the corresponding quantity threshold of 8 units. Thus the determination module will determine that the group buy purchase quality qualifies for group by deal, based on the current terms of the group buy purchase quote (i.e. 8 units for $320).

On the other hand, if the quoted priced in the group buy purchase quote is less than the predetermined threshold of the corresponding quantity, the system may reject the group buy purchase quote, or transmit the purchase quote to a designated destination (e.g. an email address of a store employee) for approval, or transmit a message back to the users requesting that the user raise their quote to the corresponding predetermined price threshold associated with the predetermined quantity that the user wishes to purchase.

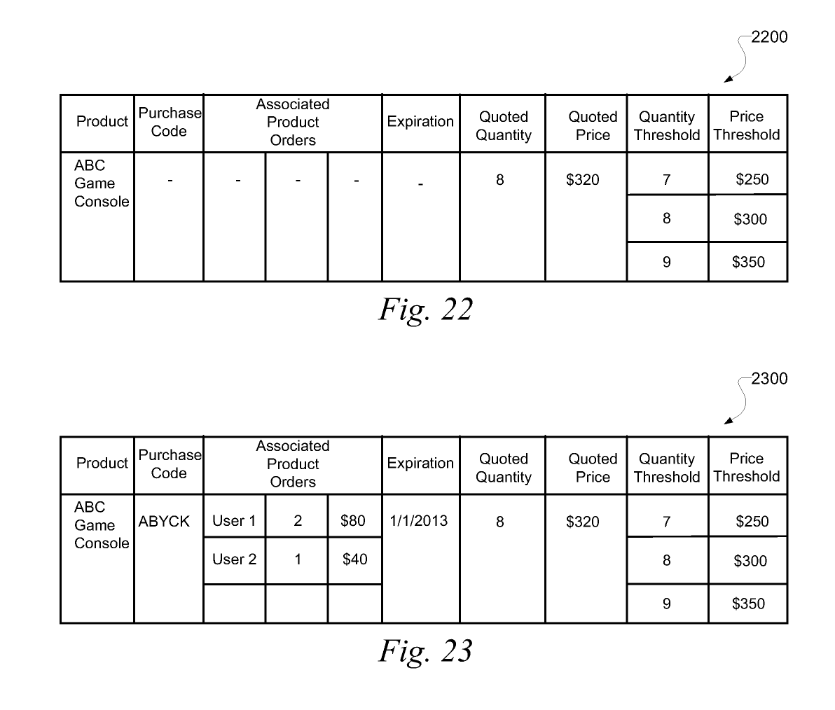

Thereafter the code management module 1600c, may generate a purchase code associated with the group buy purchase quote, and transmit the purchase code to the in-store device (e.g. kiosk), or the client device. The code management module 1600 associates the purchase code with the database entries corresponding to the group buy purchase. The purchase code may be similar to the purchase codes described elsewhere in this disclosure in accordance with various embodiments. For example, FIG. 23 illustrates a database entry 2300 similar to the database entry 2200 illustrated in FIG. 22, wherein the database entry has been updated to include information regarding a purchase code “ABYCK”. As illustrated in FIG. 23, the purchase code may be associated with the corresponding group buy purchase quote (i.e. quoted quantity and quoted price).

Since the purchase code is provided back to at least one user of the group of users that submitted the group buy purchase quote, the users may distribute the purchase code amongst themselves. Thereafter, the user may share the purchase code with other users. For example, the user may transmit the purchase code to their friends via email, text message, SMS message, instant message, chat, etc. As another example, the user may share the purchase code with their friends via the respective social media profiles of the users on an online social network website or other online media. The user may transmit the purchase code to other users using various other methods understood by those skilled in the art.

Thereafter, the group buy processing system is configured to receive one or more purchase orders for the specific item based on the group buy purchase quote, from one or more user (e.g. the members of the group that previously submitted the group buy purchase quote, and who previously received the corresponding purchase code). As described in various embodiments above, the purchase order module 1600a may process a purchase order associated with the specific product item (and identifying the purchase code), and determine that the purchase order qualifies for the group buy deal.

FIG. 23 illustrates how product orders identifying the purchase code are associated, by either purchase order module 1600a or determination module 1600c, with the purchase code in a database entry 2300. Since the received product orders identify the purchase code, the system may process each product order, based on a pro-rata share of the quoted quantity and quoted price of the group buy purchase quote. For example, since the group buy purchase quote includes a quoted quantity of 8 and a quoted price of $320, the product order for user 1 will be assessed at a cost of $80, since a pro rate share of (2/8)×$320=$80.

Alternatively, the system may charge each purchase order identifying the purchase code at full retail price as each purchase order received. After receiving an “n-th” a purchase order identifying the purchase code, wherein the combination of all the “n” received purchase orders identifying the purchase code includes a total quantity that satisfies the quoted quantity, the system processes refunds for each of the purchase orders, as discussed in various embodiments described above.

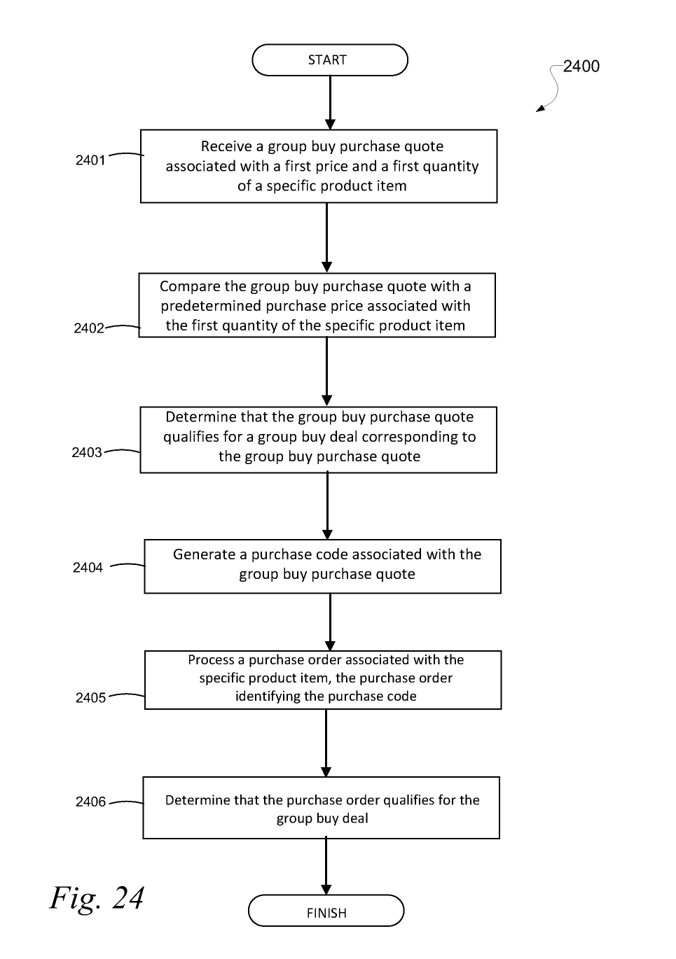

Turning now to FIG. 24, a flowchart illustrates an example method 2400, according to various embodiments. The example method 2400 may be performed by, for example, a group buy transaction system or group buy transaction device (see FIG. 16). In step 2401, the system receives a group buy purchase quote associated with a first price and a first quantity of a specific product item, the purchase order being received from a client device via a network. In step 2402, the system compares the group buy purchase quote with a predetermined purchase price associated with the first quantity of the specific product item. In step 2403, the system determines that the group buy purchase quote qualifies for a group buy deal corresponding to the group buy purchase quote. In step 2404, the system generates a purchase code associated with the group buy purchase quote, and transmits the purchase code to the client device. In step 2405, the system processes a purchase order associated with the specific product item, the purchase order identifying the purchase code. In step 2406, the system determines that the purchase order qualifies for the group buy deal.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

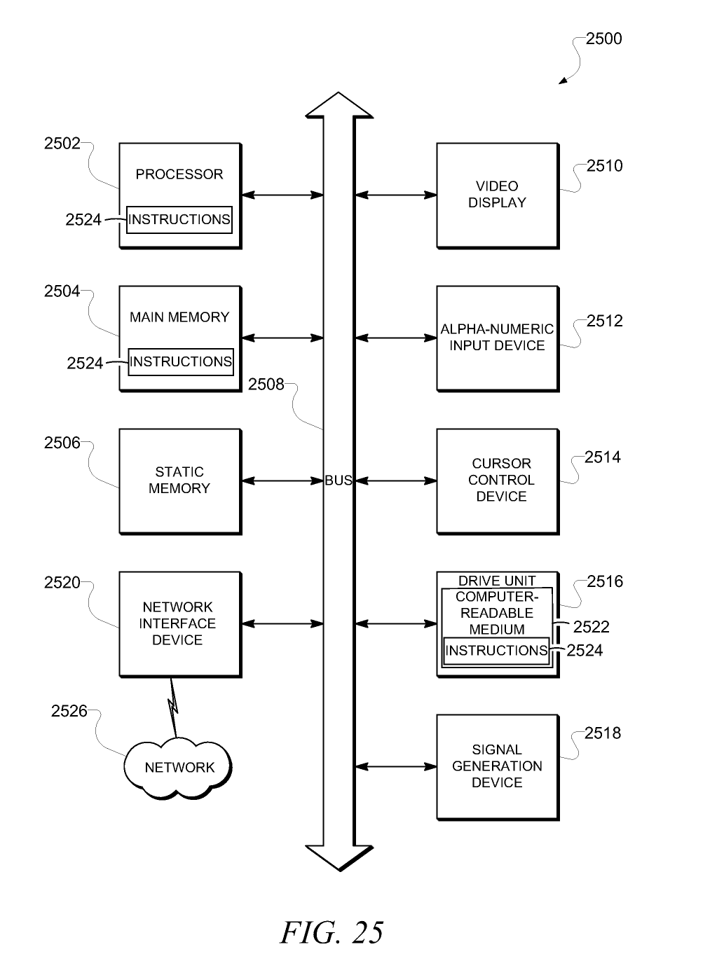

FIG. 25 is a block diagram of machine in the example form of a computer system 2500 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2500 includes a processor 2502 (e.g., a central processing unit (CPU), a graphics processing unit (GPU) or both), a main memory 2504 and a static memory 2506, which communicate with each other via a bus 2508. The computer system 2500 may further include a video display unit 2510 (e.g., a liquid crystal display (LCD) or a cathode ray tube (CRT)). The computer system 2500 also includes an alphanumeric input device 2512 (e.g., a keyboard or a touch-sensitive display screen), a user interface (UI) navigation device 2514 (e.g., a mouse), a disk drive unit 2516, a signal generation device 2518 (e.g., a speaker) and a network interface device 2520.

### Machine-Readable Medium

The disk drive unit 2516 includes a machine-readable medium 2522 on which is stored one or more sets of instructions and data structures (e.g., software) 2524 embodying or utilized by any one or more of the methodologies or functions described herein. The instructions 2524 may also reside, completely or at least partially, within the main memory 2504 and/or within the processor 2502 during execution thereof by the computer system 2500, the main memory 2504 and the processor 2502 also constituting machine-readable media.

While the machine-readable medium 2522 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 2524 may further be transmitted or received over a communications network 2526 using a transmission medium. The instructions 2524 may be transmitted using the network interface device 2520 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method for managing an online group buy transaction, the method comprising:
determining, using one or more processors, a group buy preference corresponding to a group of social media platform users, based on user profile information extracted from network-accessible social media profiles associated with the social media platform users, the group buy preference indicating a partiality of the respective social media platform users to make a purchase within a retail category;
determining a retailer corresponding to the retail category associated with the group buy preference; and
responsive to determining the group buy preference and the retailer, transmitting a notification to the retailer, the notification including an indication of the retail category and prompting the retailer to propose to the group a group buy deal corresponding to the group buy preference.

2. The method of claim 1, further comprising:
performing a textual analysis of the user profile information to determine one or more keywords in the user profile information;
associating the one or more keywords with the retail category.

3. The method of claim 1, further comprising:
performing a sentiment analysis of the user profile information to determine one or more keywords in the user profile information associated with a positive sentiment;
associating the one or more keywords with the retail category.

4. The method of claim 1, further comprising:
transmitting an online survey request to the network-accessible social media profiles associated with the social media platform users;
receiving plural survey responses via the network-accessible social media profiles; and
determining that the retail category is specified in each of the plural survey responses.

5. The method of claim 1, further comprising:
determining the group buy preference, based at least in part on purchase history information accessed via the network-accessible social media profiles associated with the social media platform users.

6. The method of claim 1, further comprising:
determining the group buy preference, based at least in part on geo-location information extracted from the network-accessible social media profiles associated with the social media platform users.

7. The method of claim 1, comprising:
receiving a user specification of one or more candidate group buy participants;
transmitting a group buy invitation to network-accessible social media profiles associated with the candidate group buy participants; and
determining the group of social media platform users, based on acceptance responses received via the network-accessible social media profiles associated with the candidate group buy participants.

8. A server apparatus comprising:
a determination module implemented using one or more processors and being configured to
determine a group buy preference corresponding to a group of social media platform users, based on user profile information extracted from network-accessible social media profiles associated with the social media platform users, the group buy preference indicating a partiality of the respective social media platform users to make a purchase within a retail category;
determine a retailer corresponding to the retail category associated with the group buy preference; and
a request generation module operable to generate and transmit notification to the retailer responsive to the determination module determining the group buy preference and the retailer, the notification including an indication of the retail category and prompting the retailer to propose to the group a group buy deal corresponding to the group buy preference.

9. The server apparatus of claim 8, wherein the determination module:
performs a textual analysis of the user profile information to determine one or more keywords in the user profile information;
associates the one or more keywords with the retail category.

10. The server apparatus of claim 8, wherein the determination module:
performs a sentiment analysis of the user profile information to determine one or more keywords in the user profile information associated with a positive sentiment;
associates the one or more keywords with the retail category.

11. The server apparatus of claim 8, wherein the determination module:
transmits an online survey request to the network-accessible social media profiles associated with the social media platform users;
receives plural survey responses via the network-accessible social media profiles; and
determines that the retail category is specified in each of the plural survey responses.

12. The server apparatus of claim 8, wherein the determination module:
determines the group buy preference, based at least in pan on purchase history information accessed via the network-accessible social media profiles associated with the social media platform users.

13. The server apparatus of claim 8, wherein the determination module:
determines the group buy preference, based at least in part on geo-location information extracted from the network-accessible social media profiles associated with the social media platform users.

14. The server apparatus of claim 8, wherein the determination module:
receives a user specification of one or more candidate group buy participants;
transmits a group buy invitation to network-accessible social media profiles associated with the candidate group buy participants; and
determines the group of social media platform users, based on acceptance responses received via the network-accessible social media profiles associated with the candidate group buy participants.

15. A non-transitory machine-readable storage medium having embodied thereon instructions executable by one or more machines to perform operations comprising:
determining, using one or more processors, a group buy preference corresponding to a group of social media platform users, based on user profile information extracted from network-accessible social media profiles associated with the social media platform users, the group buy preference indicating it partiality of the respective social media platform users to make a purchase within a retail category;
determining a retailer corresponding to the retail category associated with the group buy preference; and
responsive to determining the group buy preference and the retailer, transmitting a notification to the retailer, the request including an indication of the retail category and prompting the retailer to propose to the group a group buy deal corresponding to the group buy preference.

16. The storage medium of claim 15, wherein the operations further comprise:
performing a textual analysis of the use profile information to determine one or more keywords in the user profile information;
associating the one or more keywords with the retail category.

17. The storage medium of claim 15, wherein the operations further comprise:
performing a sentiment analysis of the user profile information to determine one or more keywords in the user profile information associated with a positive sentiment;
associating the one or more keywords with the retail category.

18. The storage medium of claim 15, therein the operations further comprise:
transmitting an online survey request to the network-accessible social media profiles associated with the social media platform users;
receiving plural survey responses via the network accessible social media profiles associated with the social media platform users; and
determining that the retail category is specified in each of the plural survey responses.

19. The storage medium of claim 15, wherein the operations further comprise:
determining the group buy preference, based at least in part on purchase history information accessed via the network-accessible social media profiles associated with the social media platform users.

20. The storage medium of claim 15, wherein the operations further comprise:
determining the group buy preference, based at least in part on geo-location information extracted from the network-accessible social media profiles associated with the social media platform users.

21.-22. (canceled)
